(19) United States
(12) Patent Application Publication
(10) Pub. No.: US 2012/0296670 A1
(43) Pub. Date: Nov. 22, 2012

(54) LEARNING TOOL FOR A TARGET GROUP

(76) Inventors: Gaurav Kapoor, Bangalore (IN); Tarun Mathur, Bell Canyon, CA (US)

(21) Appl. No.: 13/574,657

(22) PCT Filed: Feb. 4, 2011
(86) PCT No.: PCT/IB11/50497

§ 371 Date: Jul. 23, 2012

(30) Foreign Application Priority Data
Feb. 6, 2010 (IN) 304/CHE/2010

(51) Int. Cl. G06Q 50/22

(52) U.S. Cl. 705/2

(57) ABSTRACT

A learning tool for a target group is disclosed. In the exemplary embodiment the target group includes health care professionals. The tool includes a digital library relevant to the target group. The tool further includes a profiler to generate a professional profile for each health care professional. A clustering module is provided in the tool to assign each health care professional to a learning group based on the professional profile. Further the tool includes a content module to provide an adaptive content from the digital library based on the professional profile and the learning group. The tool also includes a user interface to deliver the adaptive content to each health care professional.

### TECHNICAL FIELD

The invention relates generally to a tool for delivering content to a health care professional, and more specifically to a tool for delivering adaptive content.

### BACKGROUND

In the field of marketing and also in education, there are different techniques that are employed to deliver the message or content to the target group. Currently these techniques broadly design and deliver the content based on the experience, practice and knowledge of the individuals in the target group.

Typically, most of the techniques available today follow two formats for providing the content. One is a static format, where an assumption is made regarding the average experience, practice, knowledge of the target individuals and the same content is delivered to all of them. The content remains largely static and is repeated to the next set of target audience in the same category. Most educational institutions follow this format.

The second format for providing the content is being done in the digital environment. Recently, with the advent of internet and related communication and software technologies, effort has been made to customize the content as per user requirements. This is currently being mostly done with respect to advertising and marketing of campaigns. There are some specific techniques that monitor user behavior on purchasing sites like Amazon™ or Ebay™ or credit card websites that track purchase pattern or the pattern of sites most visited and then send advertisements for related goods and services to the user. Such a manner of providing content is useful for a professional in a field, as well as a general internet surfer.

However, these techniques fall short of requirements in certain specific fields for a variety of reasons including the fact that new technologies and products are being made at a faster pace and the professionals engaged in such fields have time constraints to absorb new information and therefore do not respond to the above techniques of engagement. In health care for example, it will be of no use to provide information about a drug that the doctor is already prescribing. Therefore, medical or sales representatives are usually used to advertise and educate the doctors about any new medicine or diagnostic devices, and there is a burden on the medical representative to be apprised of the doctor's prescription preferences. Further, despite being forearmed with a doctor's preferences, the access time the medical representatives may get from the doctor is very less and the success rate for this type of advertising is going down. It has been recorded that only 8% of sales representatives make impact calls across physician clinics and only 7% of the visits with a physician last longer than two minutes.

Accordingly there is a need to provide an effective solution to engage with the health care professionals and provide relevant content.

### BRIEF DESCRIPTION

In one aspect, the invention provides a learning tool for a target group, where the target group includes health care professionals. The tool includes a digital library relevant to the target group. The tool further includes a profiler to generate a professional profile for each health care professional. A clustering module is provided in the tool to assign each health care professional to a learning group based on the professional profile. Further the tool includes a content module to provide an adaptive content from the digital library based on the professional profile and the learning group. The tool also includes a user interface to deliver the adaptive content to each health care professional.

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatic representation of a tool for delivering online content to a target group of health care professionals; and

FIG. 2 is an exemplary representative view of the main login page for the tool of the invention;

FIG. 3 is an exemplary representative view of the landing webpage after logging into the tool;

FIG. 4 is an exemplary representative view of the educational content relevant for the user;

FIG. 5 is an exemplary representative view of the webpage that is used to add user content to an existing online content;

FIG. 6 is an exemplary representative view of a webpage for user to interact with other peers; and

FIG. 7 is an exemplary representative view of a web page that allows interaction with a medical service liaison.

### DETAILED DESCRIPTION

As used herein and in the claims, the singular forms “a,” “an,” and “the” include the plural reference unless the context clearly indicates otherwise.

Online content as used herein refers to any content that is available through internet. The online content, while being made available through the internet, may also be accessed while still online, or in an offline mode as well. Methods of making online content offline are known to one of ordinary skill in the art.

Library as used herein refers to a collection of sources, resources, and services, that may be organized for easy retrieval, and includes a digital library.

Content as used herein refers to any information and experiences that may provide value for a target group. Content may be in different formats including encoded formats.

Adaptive content as used herein means content that is tailored, renewed or changed on periodic basis.

Target group as used herein refers to a primary group of individuals for which the content needs to be tailored. The target group can be based on for example, a skill, educational qualification, age group, gender, profession and different combinations of these.

Health care professionals as used herein refer to a qualified person who provide health care services professionally to any individual in need of health care services. These include, doctors, general practitioners, operating department practitioners, nurses, physicians, physician assistants, physiotherapist, health care providers, pharmacists, dietitians, therapists, paramedics, and a wide variety of other individuals that provide some type of health care.

Learning group as referred herein means a sub group within the target group that has similar education or learning objectives or has predefined and desired skill levels.

Learning objectives as referred herein means educational or skill related goals that are predefined for each learning group.

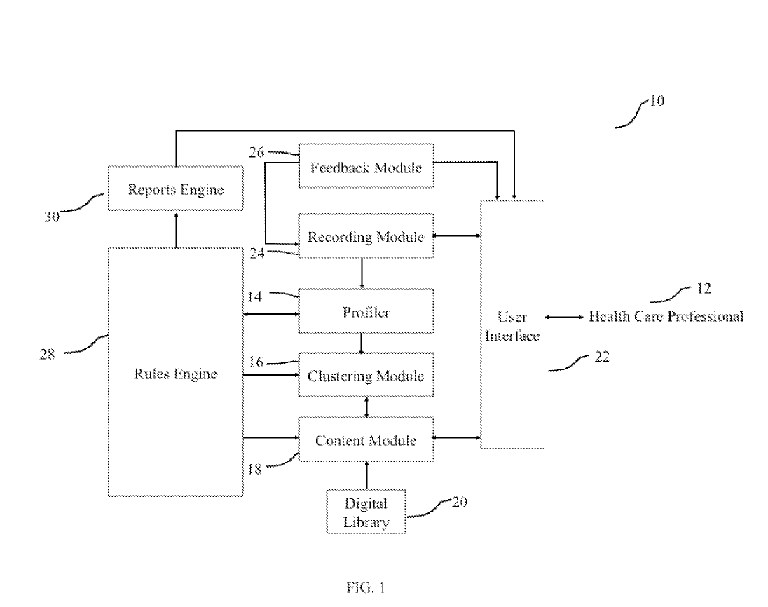

Now turning to drawings, FIG. 1 is a diagrammatic representation for a tool 10 for delivering online content to a target group. The target group includes one or more health care professionals 12, in the exemplary embodiment. However it would be understood by those skilled in the art that the target group could include professionals for any particular skill, or even students for any learning discipline.

The tool 10 comprises a profiler 14 to generate a professional profile for each health care professional, based on different attributes. In the exemplary embodiment the different attributes include personal details, learning preferences, practice details, measured attributes, and one or more tracking attributes for each health care professional. The personal details as mentioned herein may include for example, name, address, phone, years in practice, and other personal details. Learning preferences may include details related to preferred format of learning, preferred method of communication etc. The practice details may include data such as specialty, disease area, typical patient profile type, and the like. The profiler 14, in one example uses a survey to generate the professional profile for a health care professional, and further refines it by using the measured attributes and tracking attributes as described herein below.

The measured attributes as mentioned herein include measurement data received through an interaction with the health care professional related to diagnosis, treatment, and management of various disease states, specialties and therapy areas. The measured attributes are related to diagnostic aspects such as differential diagnosis, lab tests, final diagnosis, treatment, management of disease, patient etc. Some measured attributes are reasons related to brand preferences by a health care professional, some exemplary reasons include safety, efficacy, cost, tolerability etc. Some other measured attributes are related to molecule preferences such as safety, efficacy, cost, tolerability etc. Molecules, as used herein may refer to a pharmaceutical actives (also known as actives), a pharmaceutical formulations, actives are made available in various forms such as injectables, inhalants, lozenges, chewable tablets, suspensions, and the like.

The tracking attributes include formats of content viewed, time spent, ratings on content by the healthcare professional, engagement type for the health care professional. The engagement type for example, could be one of mentorship, community leader type of engagement or learner, community participant type of engagement. In operation, the tracking attributes will also include the response by the health care professional to any questionnaire that is a part of adaptive content delivered to the health care professional, the correct response, any weights based on points achieved based on correct answers, and completion status if desired.

One skilled in the art would appreciate that the profiler may assign a variety of weights and measures to each of the attributes, and subsequently, stitch together the professional profile for each health care professional accordingly. The representation of the professional profile may be done in a variety of different ways, such as a pictorial representation, a textual representation, a graphical representation, and so on, and combinations thereof as well. Further, the professional profile may be kept internal to the tool 10 or maybe communicated to the health care professional.

It may also be noted that the professional profile also comprises strength areas, and/or development needs for each health care professional based on the different attributes, the target group and the associated learning objectives.

The tool 10 further comprises a clustering module 16 to assign each health care professional to a learning group based on the professional profile received from the profiler 14. In an exemplary embodiment, each learning group is associated with corresponding learning objectives for the target group. The learning groups could be of any number for example 2, 3, 4, 5, 6, or more, based on the skill or learning discipline for the target group and the general skill levels of individuals in that learning discipline. Different analytical studies and approaches may be used to ascertain the number of learning groups. The learning objectives are set for each learning group based on the certain standards and/or any external compliance requirements in the health care domain. These compliance requirements may be typically set by jurisdiction specific administrative bodies, such as AMA (American Medical Association), FDA (Food and Drug Administration) in US, or worldwide administrative authorities such as WHO (World Health Organization).

The clustering module 16 undertakes an analysis of the professional profiles of the health care professionals with respect to the learning objectives of the different learning groups and appropriately buckets or categorizes the health care professionals in the appropriate learning group.

The tool further comprises a content module 18 for selecting and providing an adaptive content from a digital library 20 based on the professional profile and the learning group. It may be noted here that the digital library is relevant to the target group, in the exemplary embodiment the digital library is relevant to the one or more health care professionals. The content may include medical case simulation videos, technical papers and publications, webcasts, brand communications etc. Further, the content maybe in the form of audio, video, text, interactive sessions, and combinations thereof. In a specific example the content is a questionnaire. In another example, the content is a live lecture.

It would be appreciated by one skilled in the art that the selection of the adaptive content is based on development needs for each health care professional.

The adaptive content has an associated metadata to describe and identify the content type. The associated metadata includes technical parameters, for example, format type, size, expected duration, device requirements, Digital Rights Management (DRM) attributes; and target group parameters, like specialty, disease area, etc, content type for example but not limited to educational or promotional content. The associated metadata also includes the educational relevance or message relevance parameters for the adaptive content with respect to diagnostic attributes like the differential diagnosis, final diagnosis, treatment, disease or patient management; brand attributes related to safety, efficacy, cost, tolerability etc, and molecule preference based on safety, efficacy, cost, tolerability etc. It is worth noting that the educational relevance parameters for the adaptive content may match the measured attributes associated with the professional profiles of the health care professionals.

The tool 10 further comprises a user interface 22 to deliver the adaptive content to each health care professional. The user interface may be enabled through a personalized web page, or through a variety of communication modes for example but not limited to electronic mail, short messaging services, phone calls, online banner advertisements, direct mailer, in-person contact, and any another means of communication preferred by the health care professional. Further, the user interface enables an interaction between the one or more health care professionals, the adaptive content, and combinations thereof. Given a user interface, a professional profile of the health care professional and a particular nature of the adaptive content to be provided to a health care professional, the format of the adaptive content will become obvious to one skilled in the art. For example, an audio lecture session may be delivered online in a suitable digital format, such as but not limited to, .mp3 format. Similarly, in another exemplary embodiment for a reading material to be provided as the adaptive content, it may be provided as a portable document format (.pdf) or a text file (.txt), or a word document (.doc). Other such variations may be known to those of ordinary skill in the art.

The interaction as used herein implies the action of reading, providing feedback, forwarding, sending a reply or a query, deleting, rating, answering, and similar such action by the health care professional on receipt of the adaptive content.

In one embodiment, the at least one interaction comprises collaborating between the one or more health care professionals. In a specific embodiment, collaborating comprises mentoring by the one or more health care professional. In another embodiment, collaborating comprises discussion among a group of health care professionals. In yet another embodiment, collaborating comprises solving one or more problems as a group by a group of health care professionals. The one or more problems may be a real problem faced by the one or more health care professional, or may be a simulated situation provided to the group.

The tool 10 further comprises a recording module 24 for recording the interaction for each health care professional and for providing data representative of the interaction. Through the recording module, each interaction is assigned a unique interaction identity. The recording module also records different aspects related to the associated metadata of the adaptive content. The recording module 24 is capable of recording the interaction in any suitable format, such formats being dependent on various factors, such as, but not limited to, storage capacity, connectivity, nature and speed of connection (such as a broadband connection or a dial-up connection), and the like.

The tool 10 further comprises a feedback module 26, where the feedback module captures select feedback responses from the health care professional related to the adaptive content, and analyzes these responses to determine the at least one of strength areas, and or development needs for the health care professional. Such feedback is communicated to the profiler 14. The feedback module 26 captures responses in a suitable format such as a text file for future retrieval purposes. Each feedback may also be associated with some details related to the interaction to facilitate subsequent retrieval.

The tool 10 further comprises a rules engine 28 to assign rules to the data received from the different components of the tool 10 including the profiler 14, content module 18, and recording module 24, to generate an updated professional profile. It would be appreciated by those skilled in the art that the tool 10 is designed to increase the knowledge base of each health care professional based on their individual development needs. During the course of interaction with the tool 10, the development needs of the health care professional will change as they assimilate the information and move on the learning curve as per the learning objectives. The rules engine 28 therefore continuously monitors the interactions and assigns rules to meet the changing needs of the health care professional.

In the exemplary embodiment, the rules engine 28 has rules to determine a behavior profile for each health care professional based on the at least one interaction. Thus the response of the health care professional to the adaptive content leads to determination of different behavior attributes for each health care professional that are indicators of their preferences, strength areas and development needs, and the learning behavior attributes. Based on the behavior profile, the rules engine 28 updates the professional profile of the health care professional to a dynamic professional profile. It may be appreciated by those skilled in the art, that since every interaction provides inputs for behavior profile, the behavior profile gets continuously updated and consequently the professional profile gets continuously updated to provide a dynamic professional profile at any given instance of time. As noted herein above, one of the interactions is a collaborating interaction between the health care professionals. The behavior profile provides indicators towards health care professionals who could be mentors to others or who have relevant information that will help the other health care professionals. The relevant information may pertain to a disease, therapy, organ, a health care issue, a medication, a brand, a molecule and any other relevant information for another health care professional. The behavior profile will also monitor progress of a health care professional with respect to the development needs.

Further, the rules engine 26 uses the dynamic professional profile thus obtained for updating the mapping of each health care professional in the different logical groups. The rules engine has rules to determine a gap analysis with respect to the learning objectives using the dynamic profile of the health care professional. Thus the grouping of each health care professional in each of the logical groups is regularly monitored and updated based on the dynamic professional profile and communicated to the clustering module 16.

Further, the rules engine 28 also has rules to map the adaptive content to the dynamic professional profile, so that the health care professional receives adaptive content, through the content module 18 that is relevant to their current requirements and preferences. The rules search the digital library to find content containing metadata that would address the development needs of the health care professional.

The tool 10 further comprises a reports engine 30 in one exemplary embodiment. The reports engine 30 generates a variety of reports using the analysis done by the rules engine 28. The reports are useful to provide statistical data regarding the behavior profile of the health care professionals, regarding the ratings for different types of content for example marketing campaigns, regarding the different attributes of the health care professionals, and any other information that may be useful for the health care professionals or for the design of the tool, for the tool managers, for other professionals like marketing professionals, content developers and the like. For example, sample reports may show the user profile by campaign, by country, by company, by time, by specialty, by day of the week and time of the day etc. Another sample report may profile a campaign by country, by company, campaign success metrics etc. Another report may highlight product brand attributes in terms of physician perception by brand etc. The format of the report may be any suitable file format that may depend on factors, such as, but not limited to, connectivity, file size, storage capacity, and the like.

In one example the adaptive content is a campaign management content, for example a pharmaceutical communication program, and may have, for example, the following structure and associate rules: a campaign overview including campaign title, owner, start date, target group (for example, doctor, nurse, office staff, etc.), learning group (can be multiple), geographies, therapeutic area/Specialty/disease state profiles.

It may also include campaign details including rules that may be set at an aggregate level and do not depend on the number of interactions. Exemplary rules may include “Invite success rate” i.e. the number of times that health care professional responded to an invitation sent through a system that implements the method of the invention, and “Average time spent” for each health care professional interacting with content on the system.

Campaign details may include ‘Click’ events (can be multiple for a campaign), and may be referred to as ‘Interaction’ events to record the interactions. The Click events may include ‘Invite’ messages (can be multiple for a campaign) having the following parameters: Channel (SMS, email, call center), text for subject line, text for message body, and content parameters. The content parameter may be a specific content identifier or it may be a parameter that the system will use to select content. Content parameters may include multiple content entries that can be associated with an invite so long as each entry is of a different content format type. When the system sends the invite, it will send the content that most closely matches the format preferred by the health care professional. Click events will also indicate the wait time after completing the previous interaction before starting this one. Further the click event will also record the number of days of wait period after sending the invite to receive a response from the health care professional. If the health care professional does not engage with the content within this period of time, the system will send the next invite in the “Invite” queue.

Thus the tool advantageously provides real-time adaptive content to the health care professionals to improve the health care professionals' compliance with the learning objectives rather than simply complimenting the health care professionals' existing knowledge base. The tool as described herein engages the health care professionals in a constructive and contributory manner to help them increase their current knowledge base to comply with the set standards, so that each health care professional is equipped with the relevant knowledge necessary in the field of their practice. The tool is useful for ensuring the health care professional remains compliant to certain requirements and standards. The tool is also useful in sharing knowledge between professionals and spreading best practice information quickly and efficiently. Further, the tool facilitates providing specific and relevant advertising campaigns for a given health care professional by product companies, such as drug discovery companies.

Though the tool described herein is in reference with a healthcare professional, however the exemplary tool of the invention is similarly applicable to other learning fields and for different individuals in a defined target groups including students, professionals, where the method and system interactively engages with the individuals in the target group, assesses their current positioning (or level) in reference to the learning objectives, provide relevant content to enhance their learning, and facilitates them to reach the desired position in the learning field. Thus aspects of the disclosed also include a tool for providing content and influencing desired behavior of an individual or a group.

It may be appreciated by one skilled in the art that the method and process steps and algorithms described herein can be executed by means of software running on a suitable processor, or by any suitable combination of hardware and software. When software is used, the software can be accessed by a processor using any suitable reader device which can read the medium on which the software is stored. The computer readable storage medium can include, for example, magnetic storage media such as magnetic disc or magnetic tape; optical storage media such as optical disc, optical tape, or machine readable bar code; solid state electronic storage devices such as random access memory (RAM) or read only memory (ROM); or any other physical device or medium employed to store a computer program. The software carries program code which, when read by the computer, causes the computer to execute any or all of the steps of the methods disclosed in this application.

The hardware requirements to enable the healthcare professional to utilize the tool of the invention will be obvious to one of ordinary skill in the art. An exemplary hardware requirement for viewing and reading the adaptive content includes a monitor having sufficient screen resolution, such as, for example, 1024×768. Another exemplary hardware for answering questionnaire may include, for example a touch screen or a keyboard. Further, voice-enabled responses for questionnaires, and for collaboration purposes, a microphone of suitable quality may be used. Lecture sessions may be heard over speakers that may be built into a computer or that may be external to the computer. Also, collaboration in the tool of the invention may use a video recording device, such as a webcam. Such video recording devices may be built into a computer, or may be external to the computer. Similarly a communication link that may be an ordinary link or a dedicated communication link may be provided for accessing the tool as described herein from a user's work station. Other hardware requirements to use the tool of the invention will become obvious to one of ordinary skilled in the art and are contemplated within the scope of the invention. Accordingly, a computer that is used for the tool of the invention will also have sufficient processing capabilities, such as processor speed, voice card, software for voice recognition, image recognition software, and the like.

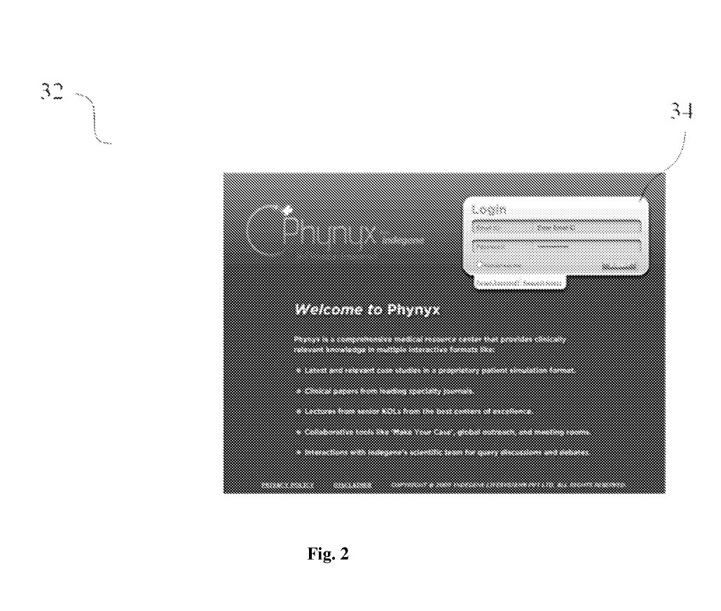

FIG. 2 shows a representative view of a manifestation of the tool of the invention in the form of a computer program that has been executed to display a webpage, as represented by numeral 32. Here, the login is shown through the use of a unique email id and a password, as depicted by numeral 34 in FIG. 2. However, one of ordinary skill in the art will appreciate that the user name could be a unique user id, or the login could be on the basis of a unique internet protocol (IP) address that has been enabled to access the tool.

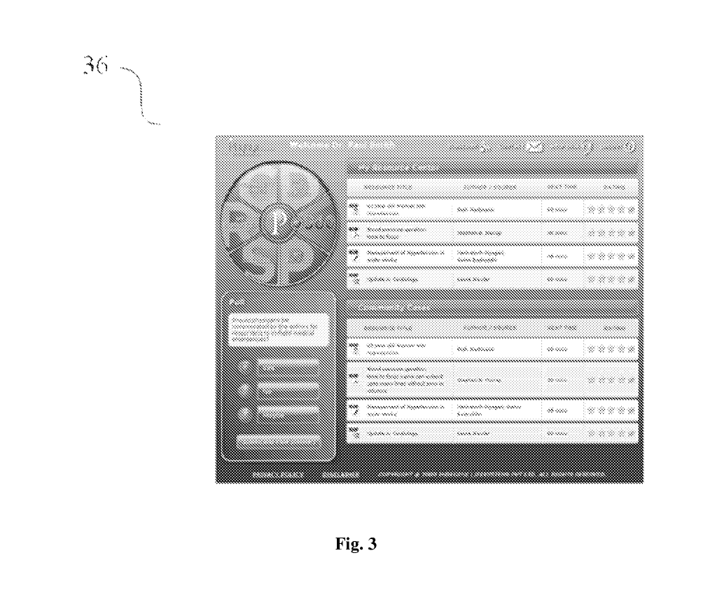

FIG. 3 shows an exemplary representative view of a landing page after the initial successful login into the tool of the invention, as depicted by numeral 36. The content of the landing page comprises relevant information derived from the adaptive content that is obtained from the library based on the behavior of the user as described herein.

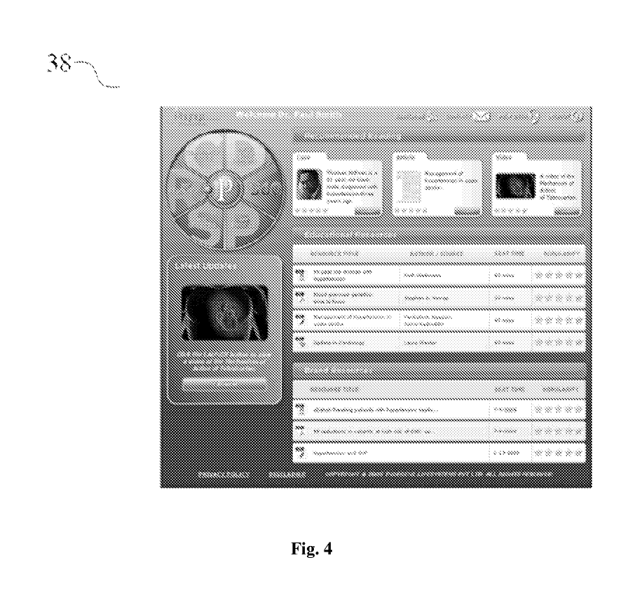

FIG. 4 is an exemplary representative view of the educational content relevant for the user, as depicted by numeral 38. The educational content, as described herein, is customized to specific user, and is derived from the library to provide the adaptive content based on the behavioral pattern, and other attributes, as already provided herein. The content may also be rated, wherein the ratings is based on rules developed that are specific to the user based on the rules engine of the tool of the invention. The ratings may be in any relevant form as known to one of ordinary skill in the art, and may include, for example, a star-ratings, a ranking system, and the like. Thus, a 5-star rated content may indicate to the user that the content is of high relevance and/or importance, and requires immediate attention, whereas a lower star rating may be less relevance and/or importance.

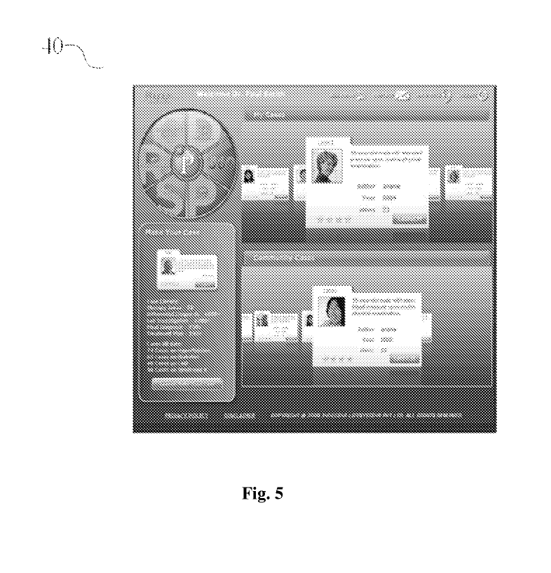

FIG. 5 is an exemplary representative view of the webpage that is used to add user content to an existing online content by the user, as depicted by numeral 40. The user content may be, for example, in one embodiment, relevant case studies that the user wishes to share with peer network. In another embodiment, the user content that the user wishes to add may be a relevance rating or importance rating for a particular case study or a response to a question. In yet another embodiment, the user content that the user wishes to add may be comments to an existing case study or a response to indicate further details. Other variations will become obvious to one skilled in the art, and is contemplated to be within the scope of the invention.

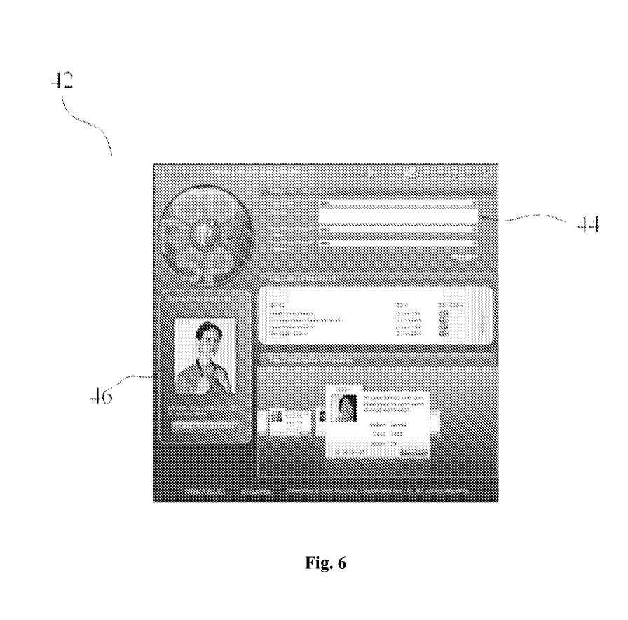

FIG. 6 is an exemplary representative view of a webpage for user to interact with other peers, as depicted by numeral 42. In one embodiment, the nature of interaction may be in the form of a query posted to a specific peer or a group of peers, as shown in FIG. 6 by numeral 44. The query may reach the peer or group of peers in the form of an email or other means of communication, such as a short message service (SMS) or the like, or combinations thereof. In an exemplary embodiment, the entire query may reach the peer through an email, while an SMS may be sent to the peer indicating that a query has been received in the peer's inbox. In another embodiment, the interaction with a peer may be through a video chat. The clickable link to a video chat is shown in FIG. 6 by numeral 46. As shown in this exemplary view, the identity of the available peer is shown in the form of name and a photograph. In other embodiments, the clickable link is used to schedule an appointment with a peer for a video chat or an audio chat, and the like.

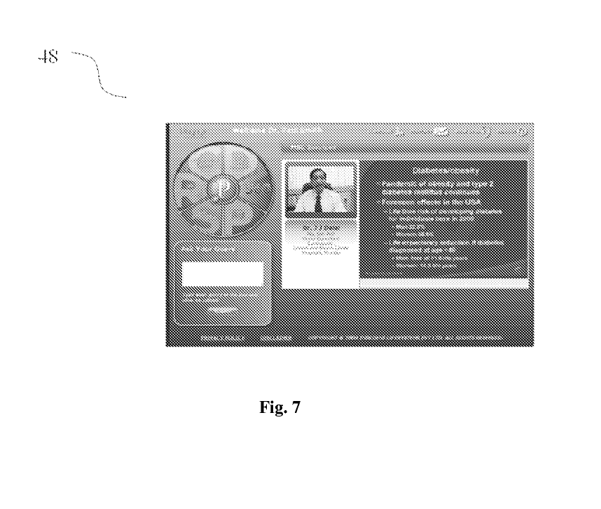

FIG. 7 is an exemplary representative view of a web page that allows interaction with a Medical Service Liaison (MSL), as depicted by numeral 48. MSLs are professionals who have advanced medical, pharmacy or science degrees and offer credibility and objectivity of a peer, and further also provide an insider's knowledge of companies and products. MSLs coordinate the flow of clinical information and manage important key opinion leader (KOL) relationships, which can be critical to a product's success at any stage of its life cycle. MSLs typically have a thorough knowledge of specific disease states and the science that supports certain products within those disease states. MSLs are also involved in providing medical scientific information and literature for physician education may further be involved with planning medical education activities such as symposia, etc. The tool of the invention further facilitates interaction with MSLs relevant to the user of the tool.

As already indicated herein, all interactions may further by the tool of the invention. The recorded interactions may be used in the future for further demonstration, for teaching purposes, for reviewing and improving oneself, and so on. Other relevant purposes towards the using of recorded interactions will become obvious to one skilled in the art, and is contemplated to be within the scope of the invention.

While only certain features of the invention have been illustrated and described herein, many modifications and changes will occur to those skilled in the art. It is, therefore, to be understood that the appended claims are intended to cover all such modifications and changes as fall within the true spirit of the invention.

I/We claim:

1. A learning tool for a target group comprising:
a digital library relevant to a target group, wherein the target group comprises one or more health care professionals;
a profiler to generate a professional profile for each health care professional;
a clustering module to assign each health care professional to a learning group based on the professional profile;
a content module to provide an adaptive content from the digital library based on the professional profile and the learning group; and
a user interface to deliver the adaptive content to each health care professional.

2. The tool of claim 1 wherein the professional profile is based on a plurality of attributes for each health care professional.

3. The tool of claim 1 wherein the user interface enables an interaction between the one or more health care professionals, the adaptive content, and combinations thereof.

4. The tool of claim 3 further comprising a recording module for recording the interaction and for providing data representative of the interaction.

5. The tool of claim 4 wherein the interaction is assigned a unique interaction identity.

6. The tool of claim 4 further comprising a rules engine to assign rules to the data to generate an updated professional profile.

7. The tool of claim 6 further comprising a reports engine to generate one or more reports based at least on dynamic professional profile.

8. The tool of claim 1 wherein the profiler uses a survey to generate the professional profile.

9. The tool of claim 1 wherein the content is in the form of audio, video, text, interactive sessions, and combinations thereof.

10. The tool of claim 1 wherein the content is a questionnaire.

11. The tool of claim 1 wherein the content is a live lecture.

12. The tool of claim 1 wherein the tool further comprises a feedback module, wherein the feedback is at least one of strength areas, development needs.

13. A system that comprises the tool of claim 1.

14. A computer program product comprising: a computer useable medium having a computer readable code including instructions for:
generating a professional profile for each health care professional;
assigning each health care professional to a learning group based on the professional profile;
providing an adaptive content from a digital library based on the professional profile and the learning group; and
delivering the adaptive content to each health care professional.
